(19) United States
(12) Patent Application Publication
(10) Pub. No.: US 2024/0079832 A1
(43) Pub. Date: Mar. 7, 2024

(54) CONNECTOR PANEL

(71) Applicant: Mitsubishi Electric Corporation, Tokyo (JP)

(72) Inventors: Yoshiyuki KUSANO, Tokyo (JP); Kenji HIROSE, Tokyo (JP); Kyota OTSUKA, Tokyo (JP)

(73) Assignee: Mitsubishi Electric Corporation, Tokyo (JP)

(21) Appl. No.: 18/384,928

(22) Filed: Oct. 30, 2023

Related U.S. Application Data
(63) Continuation of application No. PCT/JP2021/023156, filed on Jun. 18, 2021.

(51) Int. Cl. H01R 24/52; H01R 13/52; H01R 13/639

(52) U.S. Cl. CPC H01R 24/52; H01R 13/52; H01R 13/6395

(57) ABSTRACT

A connector panel includes: a disc-shaped panel base that has a first screw portion on an outer circumferential surface of the panel base; an attachment that has a first cylindrical portion and a flange, the attachment having a second screw portion at a first-end portion of an inner circumferential surface of the first cylindrical portion; and an intermediate support whose inner circumferential surface has a third screw portion to which the first screw portion of the panel base is to be screwed, and whose outer circumferential surface has a fourth screw portion to which the second screw portion of the attachment is to be screwed, the intermediate support having a second cylindrical portion that is to be disposed coaxially with the first cylindrical portion of the attachment.

### CROSS REFERENCE TO RELATED APPLICATIONS

This application is a Continuation of PCT International Application No. PCT/JP2021/023156, filed on Jun. 18, 2021, which is hereby expressly incorporated by reference into the present application.

### TECHNICAL FIELD

The present disclosure relates to a connector panel that has a plurality of connectors, and is to be attached to a structure that serves as a shield between an inside area and an outside area.

### BACKGROUND ART

Patent Literature 1 depicts a screw-fastening-type connector which enables screw engagement between male and female screw structures with different diameters by using a connection attachment with a screw structure to interlink them.

On the other hand, in one technology having been considered for connecting the areas outside and inside a shielded closed space such as an electromagnetic anechoic chamber by using a plurality of signal cables or the like, instead of individually attaching a plurality of connectors to a structure that serves as a shield between the outside area and the inside area such as a shielding wall, a connector panel having a plurality of connectors is attached to an opening provided in the structure, thereby connecting the areas inside and outside the structure by using the plurality of signal cables or the like while ensuring the shielding property (shield performance).

### CITATION LIST

### Patent Literature

Patent Literature 1: JP H07-130427 A

### SUMMARY OF INVENTION

### Technical Problem

If the screw-fastening-type connector depicted in Patent Literature 1 is used for the plurality of connectors in the connector panel attached to the opening of the structure, the clamping property of the connectors improves, but desirably the connector panel has the following features.

That is, desirably the connector panel can ensure its shielding property in a case where it is attached to the opening of the structure, and additionally it allows one to easily perform work of removing the connector panel from the structure, and to easily perform work of attaching the removed connector panel to the structure in a case where maintenance of cables connected to the plurality of connectors is performed.

The present disclosure has been made in view of the matters described above, and an object thereof is to obtain a connector panel that ensures its shielding property (shield performance), and allows one to easily perform removal work of a panel base to which a plurality of connectors are attached, and to easily perform attachment work of the removed panel base.

### Solution to Problem

A connector panel according to the present disclosure includes: a disc-shaped panel base that has a first screw portion on an outer circumferential surface of the panel base and to which a plurality of connectors are to be attached in such a manner that a first-end portion of each of the plurality of connectors protrudes on a first-surface side of the panel base, and a second-end portion of each of the plurality of connectors protrudes on a second-surface side of the panel base; an attachment that has a first cylindrical portion and a flange formed integrally with the first cylindrical portion, the flange being configured to be fixed to an edge portion circumscribing an opening provided in a structure that serves as a shield between an area inside the structure and an area outside the structure, the attachment having a second screw portion at a first-end portion of an inner circumferential surface of the first cylindrical portion; and an intermediate support whose inner circumferential surface has a third screw portion to which the first screw portion of the panel base is to be screwed, and whose outer circumferential surface has a fourth screw portion to which the second screw portion of the attachment is to be screwed, the intermediate support having a second cylindrical portion that is to be disposed coaxially with the first cylindrical portion of the attachment.

### Advantageous Effects of Invention

According to the present disclosure, the panel base to which the plurality of connectors are to be attached is to be attached, via the intermediate support, to the attachment fixed to a surface of the structure. This allows one to easily perform work of removing the panel base from the attachment, and to easily perform work of attaching the panel base while ensuring the shield performance in relation to the structure.

### BRIEF DESCRIPTION OF DRAWINGS

FIG. 1 is a perspective view depicting a connector panel according to a first embodiment.

FIG. 2 is a cross-sectional view taken along A-A depicted in FIG. 1.

FIG. 3 is a front view depicting an intermediate support in the connector panel according to the first embodiment.

FIG. 4 is a cross-sectional view taken along B-B depicted in FIG. 3.

FIG. 5 is an enlarged view of a portion C depicted in FIG. 4.

FIG. 6 is an enlarged cross-sectional view of a main portion in the connector panel according to the first embodiment depicting an arrangement state before screw engagement.

FIG. 7 is an enlarged cross-sectional view of a main portion in the connector panel according to the first embodiment depicting a screwed state after screw engagement.

FIG. 8 is an enlarged cross-sectional view of a main portion in a connector panel according to a second embodiment depicting an arrangement state before screw engagement.

FIG. 9 is a front view depicting an intermediate support in a connector panel according to a third embodiment.

FIG. 10 is a cross-sectional view taken along D-D depicted in FIG. 9.

FIG. 11 is an enlarged view of a portion E depicted in FIG. 10.

FIG. 12 is an enlarged cross-sectional view of a main portion of the connector panel according to the third embodiment depicting a screwed state after screw engagement.

FIG. 13 is an enlarged cross-sectional view of a main portion of a connector panel according to a fourth embodiment depicting a screwed state after screw engagement.

FIG. 14 is a perspective view depicting a connector panel according to a fifth embodiment.

FIG. 15 is a cross-sectional view taken along F-F depicted in FIG. 14.

### DESCRIPTION OF EMBODIMENTS

### First Embodiment

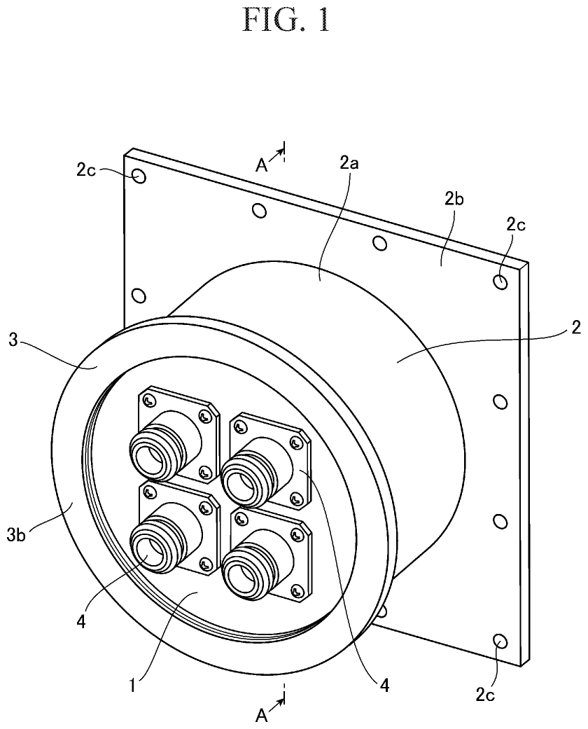

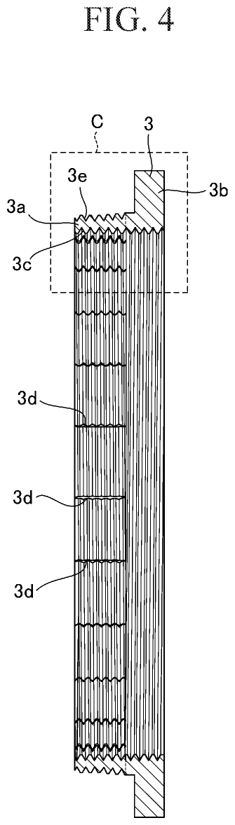

A connector panel according to a first embodiment is explained on the basis of FIG. 1 to FIG. 7.

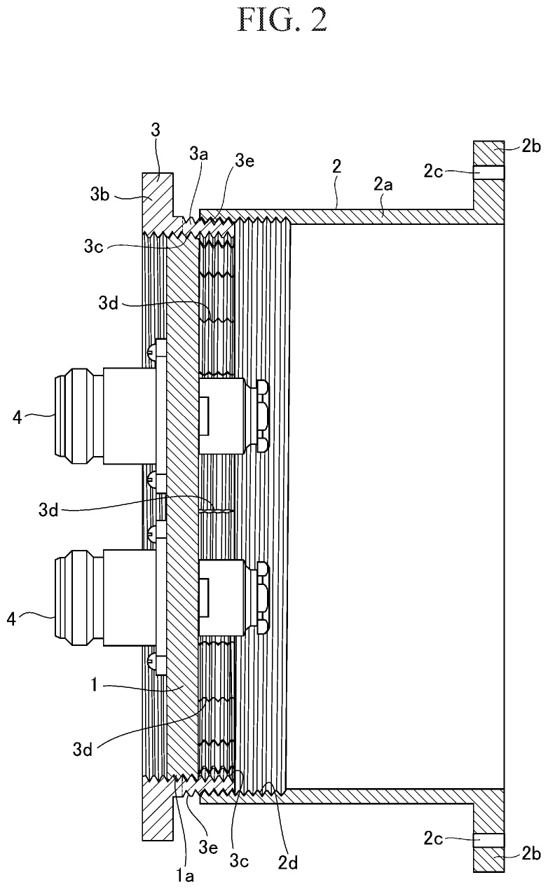

As depicted in FIG. 1 and FIG. 2, the connector panel includes a panel base 1, an attachment 2, an intermediate support 3 and a plurality of connectors 4.

The connector panel is to be attached to a structure (not depicted in the figures) which is a wall that serves as a shield between the areas inside and outside a shielded closed space such as an electromagnetic anechoic chamber. In a case where the connector panel is attached to a cylindrical through hole provided in the wall which is a structure, the front-surface side of the connector panel is positioned in the area outside the electromagnetic anechoic chamber, and the rear-surface side of the connector panel is positioned in the area inside the electromagnetic anechoic chamber, in the first embodiment.

A radio wave absorber is attached on the rear surface of the wall forming the electromagnetic anechoic chamber.

The panel base 1 is a disc-shaped conductive material having a first screw portion 1a formed on the outer circumferential surface.

The first screw portion 1a is a male parallel screw.

The plurality of the connectors 4 are attached to the panel base 1 in such a manner that a first-end portion of each of them protrudes on a first-surface side which is the front-surface side, and a second-end portion of each of them protrudes on a second-surface side which is the rear-surface side.

A radio wave absorber (not depicted in the figures) is attached to the rear surface of the panel base 1.

In addition, although not depicted in the figures, a port to connect the areas inside and outside the electromagnetic anechoic chamber such as a penetrating pipe that penetrates the panel base 1 from the front-surface side to the rear-surface side is mounted on the panel base 1.

The outline portion of each of the plurality of connectors 4 includes a conductive material for shielding. Each of the plurality of connectors 4 is fixed to the panel base 1 at its four corners by screwing. Thus, each of the plurality of connectors 4 is given a potential which is the same as the potential of the panel base 1, that is, the ground potential.

In addition, each of the plurality of connectors 4 has a first terminal that is provided at the first-end portion thereof and is connected with a first harness cable (not depicted in the figures) such as a signal cable, and a second terminal that is provided at the second-end portion thereof and is connected with a second harness cable (not depicted in the figures) such as a signal cable.

Each of the plurality of connectors 4 is an N-type connector that electrically connects the first harness cable and the second harness cable that are provided in the areas outside and inside the wall which is a structure forming the electromagnetic anechoic chamber.

The number of the connectors 4 is four as an example, but is not limited to four.

The attachment 2 has a first cylindrical portion 2a and a first flange 2b that is formed integrally with the first cylindrical portion 2a at a second end of the first cylindrical portion 2a. The attachment 2 is a conductive material and is grounded.

The first cylindrical portion 2a is inserted into an opening provided in the structure from the area inside the structure in such a manner that the outer circumferential surface of the first cylindrical portion 2a tightly contacts the structure.

The first flange 2b has a plurality of screw through holes 2c that are formed therein at constant intervals along its periphery. The first flange 2b is fixed to an edge portion circumscribing the opening provided in the structure, that is, the edge portion, on the inner-surface side, circumscribing the opening provided in the wall which is a structure, at multiple points using screws penetrating the screw through holes 2c.

Note that attachment of the attachment 2 to the structure is not limited to the manner in which the first cylindrical portion 2a is inserted into the opening provided in the structure in such a manner that the outer circumferential surface of the first cylindrical portion 2a tightly contacts the structure, and then the first flange 2b is fixed to the edge portion circumscribing the opening on the inner-surface side.

For example, attachment of the attachment 2 to the structure may be performed in a manner in which the internal diameter of the first cylindrical portion 2a is made the same as the internal diameter of the opening provided in the structure, the first cylindrical portion 2a is disposed on the outer side of the structure while communicating with the opening, and then the first flange 2b is fixed to an edge portion circumscribing the opening on the outer-surface side.

The first cylindrical portion 2a has a second screw portion 2d formed on the inner circumferential surface thereof and at a first-end portion thereof positioned opposite the first flange 2b.

The second screw portion 2d is a female parallel screw.

Since the attachment 2 is grounded by being fixed to the opening provided in the structure, its shielding property is ensured. Thus, the first cylindrical portion 2a shields the second harness cables that are inserted therein.

The intermediate support 3 is screwed to the panel base 1 and the attachment 2 between the panel base 1 and the attachment 2, thereby attaching the panel base 1 to the attachment 2. The intermediate support 3 is a conductive material, and is grounded by the attachment 2. Thereby, the intermediate support 3 grounds the panel base 1. Since, as a result, the panel base 1, the attachment 2 and the intermediate support 3 are electrically connected and grounded, the shield performance is satisfied.

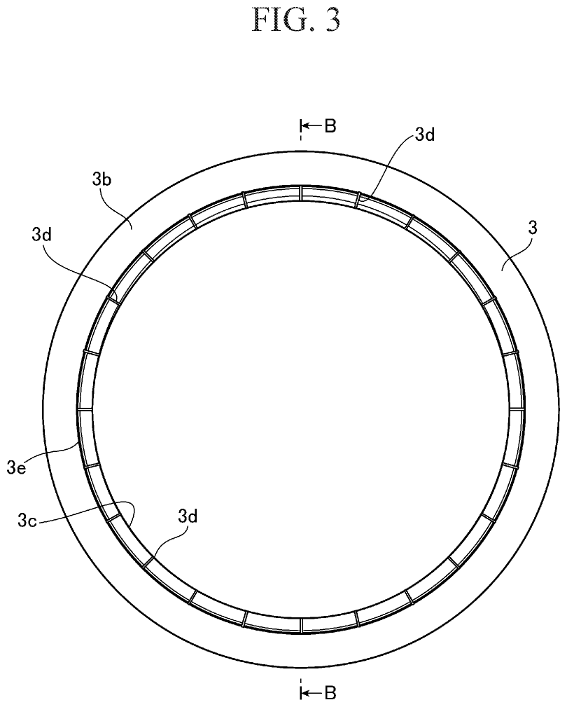

As depicted in FIG. 3 to FIG. 5, the intermediate support 3 has a second cylindrical portion 3a that communicates with the first cylindrical portion 2a of the attachment 2, and a second flange portion 3b that is formed integrally with the second cylindrical portion 3a at a first end of the second cylindrical portion 3a.

The intermediate support 3 has, over the entire inner circumferential surface thereof, a third screw portion 3c to which the first screw portion 1a of the panel base 1 is screwed. The third screw portion 3c is a female parallel screw.

The third screw portion 3c has the same screw size as the first screw portion 1a of the panel base 1.

The intermediate support 3 has, over the entire outer circumferential surface of the second cylindrical portion 3a, a fourth screw portion 3e to which the second screw portion 2d of the attachment 2 is screwed.

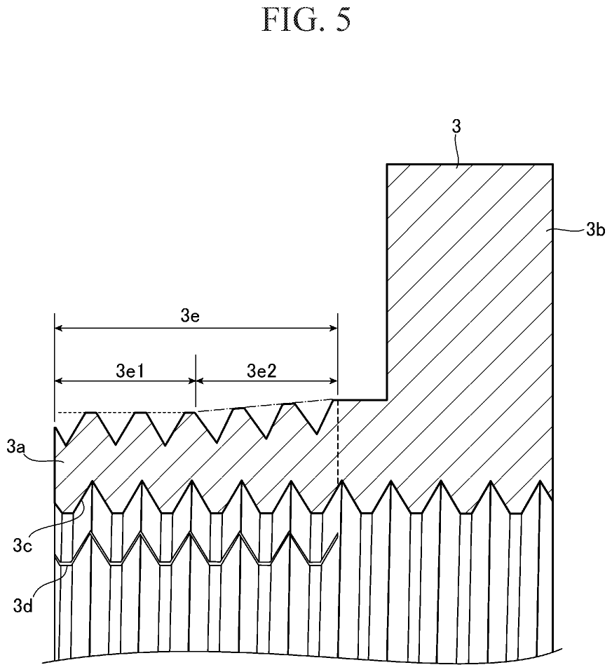

As depicted in FIG. 5, the fourth screw portion 3e is a male screw having a male parallel screw 3e1 and a male taper screw 3e2 that is continuous with the parallel screw 3e1.

Particularly, as represented by solid lines in FIG. 5, the intermediate support 3 has, at a portion of the second cylindrical portion 3a where the fourth screw portion 3e is formed, a plurality of slits 3d at constant intervals along the circumferential direction. The slits 3d are parallel to the central axis of the second cylindrical portion 3a.

Each slit 3d is a slit that is formed in the second cylindrical portion 3a continuously from a second-end surface of the second cylindrical portion 3a, that is, the starting end of the fourth screw portion 3e to the terminating end of the fourth screw portion 3e, while penetrating the second cylindrical portion 3a from its outer surface to its inner surface.

The parallel screw 3e1 is formed at the beginning portion of the screw thread, that is, at the portion that starts from the second end of the second cylindrical portion 3a. The parallel screw 3e1 has the same screw size as the second screw portion 2d of the attachment 2.

The taper screw 3e2 is formed at the terminating portion of the screw thread, that is, at the portion that is continuous with the terminating end of the parallel screw 3e1 and extends to the first end of the second cylindrical portion 3a. The taper screw 3e2 has an outer diameter which increases toward the terminating end of the screw, that is, toward the second flange portion 3b. In summary, the taper screw 3e2 has a taper structure whose outer diameter gradually increases toward the terminating end of the screw relative to the size of the parallel screw 3e1.

The direction of screw engagement between the first screw portion 1a in the panel base 1 and the third screw portion 3c in the intermediate support 3 is opposite to the direction of screw engagement between the second screw portion 2d in the attachment 2 and the fourth screw portion 3e in the intermediate support 3. That is, the direction of screw engagement between the first screw portion 1a and third screw portion 3c and the direction of screw engagement between the second screw portion 2d and the fourth screw portion 3e have a relationship in which one is a direction of left-hand screws, and the other is a direction of right-hand screws.

Next, a manner of attachment of the connector panel according to the first embodiment to the opening which is a through hole of the wall of the electromagnetic anechoic chamber which is a structure is explained.

First, the attachment 2 is fixed to the opening provided in the wall.

That is, the first cylindrical portion 2a of the attachment 2 is inserted into the opening from the inner side of the wall in such a manner that the outer circumferential surface of the first cylindrical portion 2a tightly contacts the wall, and the first flange 2b is fixed to the inner surface of the wall which is the edge portion circumscribing the opening by inserting screws through the screw through holes 2c, and screwing them together.

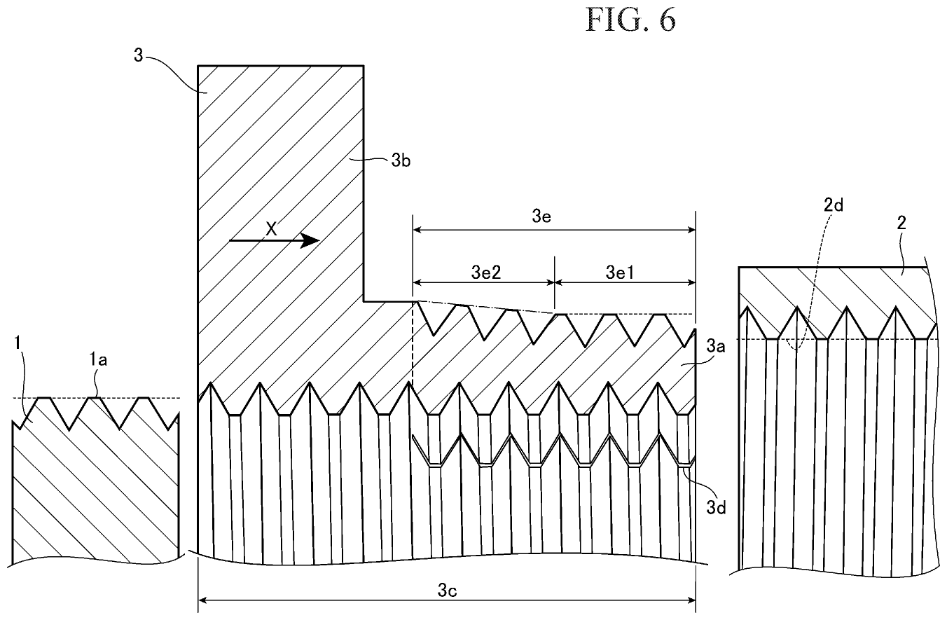

Next, as depicted in FIG. 6, the open end on the second-end side of the intermediate support 3 and the open end on the first-end side of the attachment 2 are caused to face each other in a coaxial state, the fourth screw portion 3e of the intermediate support 3 is pressed against the second screw portion 2d of the attachment 2, and the intermediate support 3 is rotated clockwise.

Then, since the parallel screw 3e1 of the fourth screw portion 3e is screwed to the second screw portion 2d, and they have right-hand screw structures, the intermediate support 3 advances in the X direction in the figure, and the intermediate support 3 is loosely attached to the attachment 2.

In this state, the rear surface, which is on the second-end side, of the panel base 1 and the open end on the first-end side of the intermediate support 3 are caused to face each other in a coaxial state, the first screw portion 1a of the panel base 1 is pressed against the third screw portion 3c of the intermediate support 3, and the intermediate support 3 is rotated clockwise.

Although not depicted in FIG. 6, each of the plurality of connectors 4 attached to the panel base 1 is connected with the second harness cable at its second terminal provided at its second-end portion.

In addition, a radio wave absorber which is the same as the one provided on the surface of the wall which is a structure is attached to the rear-surface side, which is the second-end side, of the panel base 1.

At this time, the panel base 1 is not rotated, but only the intermediate support 3 is rotated clockwise. Since the first screw portion 1a is screwed to the third screw portion 3c, and they have left-hand screw structures, the panel base 1 advances in the X direction in the figure, and the panel base 1 is attached to the intermediate support 3. Simultaneously, the intermediate support 3 advances in the X direction in the figure, and the intermediate support 3 is attached to the attachment 2.

Since the panel base 1 is not rotated when the panel base 1 is attached, the second harness cables, each of which is connected to the corresponding one of the plurality of connectors 4, are not twisted.

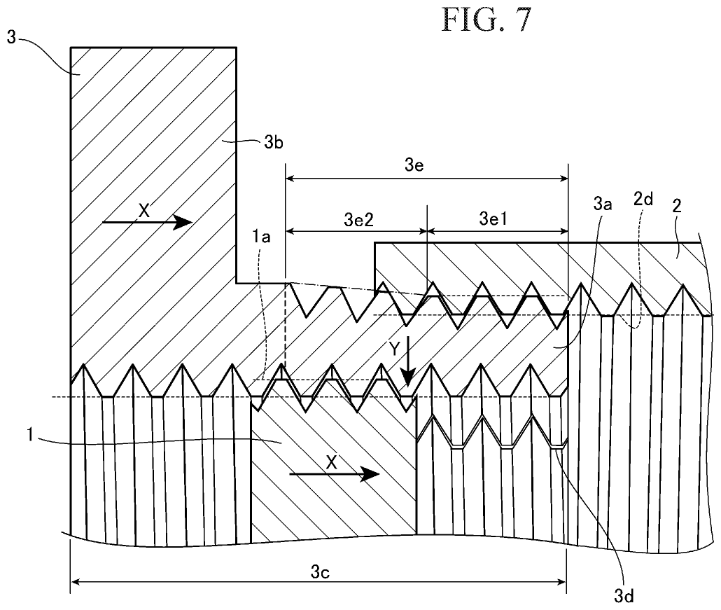

This state is depicted in FIG. 7.

FIG. 7 depicts the final stage at which the panel base 1 is attached to the attachment 2 via the intermediate support 3.

As depicted in FIG. 7, a part of the taper screw 3e2 which is continuous with the parallel screw 3e1 in the fourth screw portion 3e in the intermediate support 3 is screwed to the second screw portion 2d of the attachment 2. In addition, the surface on the second-end side of the second flange portion 3b in the intermediate support 3 is made flush with the rear surface of the wall which is a structure.

Since the first flange 2b of the attachment 2 and the second flange portion 3b of the intermediate support 3 sandwich the wall in such a manner that they tightly contact both surfaces of the wall, the shield performance is high.

The reason why both the intermediate support 3 and the panel base 1 advance in the X direction in the figure when only the intermediate support 3 is rotated clockwise is because the direction of screw engagement between the first screw portion 1a in the panel base 1 and the third screw portion 3c in the intermediate support 3 is opposite to the direction of screw engagement between the second screw portion 2d in the attachment 2 and the fourth screw portion 3e in the intermediate support 3, that is, they have a relationship in which one is a direction of left-hand screws, and the other is a direction of right-hand screws.

Accordingly, since the panel base 1 is attached to the attachment 2 via the intermediate support 3 by rotating only the intermediate support 3, the attachment work is easy.

In addition, when the part of the taper screw 3e2 of the fourth screw portion 3e in the intermediate support 3 is screwed to the second screw portion 2d of the attachment 2, force is applied in the direction of the arrow Y in the figure by the taper screw 3e2 being pressed by the second screw portion 2d of the attachment 2 since the outer diameter of the taper screw 3e2 in the fourth screw portion 3e increases gradually along with the insertion of the taper screw 3e2.

As a result, a portion of the intermediate support 3 where the taper screw 3e2 is formed elastically deforms in the direction of the arrow Y in the figure due to the plurality of slits 3d formed at a portion of the second cylindrical portion 3a where the fourth screw portion 3e is formed in the intermediate support 3, and thereby the intermediate support 3 is caused to tightly contact the attachment 2 rigidly.

In addition, along with the elastic deformation of the taper screw 3e2 in the direction of the arrow Y in the figure, the third screw portion 3c in the intermediate support 3 also elastically deforms in the direction of the arrow Y in the figure, thereby the panel base 1 also receives force in the direction of the arrow Y in the figure by being pressed by the first-end portion of the intermediate support 3, and thereby the panel base 1 also is caused to tightly contact the intermediate support 3 rigidly.

The shield performance attained by the panel base 1, the attachment 2 and the intermediate support 3 including conductive materials improves further since the attachment 2 and the intermediate support 3 are caused to tightly contact with each other rigidly, and the intermediate support 3 and the panel base 1 are caused to tightly contact with each other rigidly.

After the panel base 1 is attached to the attachment 2 via the intermediate support 3 in this manner, each of the plurality of connectors 4 attached to the panel base 1 is connected with the first harness cable at the first terminal provided on the first-end side.

Next, the following explains a manner of removal of the panel base 1 from the attachment 2 when maintenance work is performed to inspect or repair the second harness cables, to inspect or repair the plurality of connectors 4 or the like, and so on, or work is performed to change connection of the second harness cables, change the connectors 4, place new second harness cables, remove the second harness cables, and so on.

A manner of removal of the panel base 1 from the attachment 2 is basically the reverse of the manner of attachment of the panel base 1 to the attachment 2 explained in the description above.

First, the first harness cable connected to the first terminal of each of the plurality of connectors 4 is removed.

Since the front surface, which is on the first-end side, of the panel base 1 is an exposed surface, removal of the first harness cables from the first terminals of the connectors 4 is easy.

At this time, all the first harness cables may be removed from the first terminals of the connectors 4 or only first harness cables that are required to be removed when maintenance work or the like is to be performed may be removed.

Even when only the required first harness cables are removed, this will not cause any problem to work to be performed later.

Next, while keeping the panel base 1 unrotated, only the intermediate support 3 is rotated counterclockwise in a direction which is opposite to the direction in which the intermediate support 3 is rotated at the time of attachment.

Then, starting from the state depicted in FIG. 7, the panel base 1 advances in the direction which is opposite to the direction of the arrow X in the figure, and simultaneously the intermediate support 3 advances in the direction which is opposite to the X direction depicted in the figure.

The first screw portion 1a of the panel base 1 is unscrewed from the third screw portion 3c, and thus the panel base 1 can be removed from the intermediate support 3.

Accordingly, it becomes possible to remove the second harness cables from the second terminals of the connectors 4, and thereby maintenance work of the second harness cables and the plurality of connectors 4 can be performed.

The intermediate support 3 may remain loosely attached to the attachment 2 or the intermediate support 3 may be removed from the attachment 2 by being rotated counterclockwise.

The panel base 1 can be removed from the intermediate support 3 by rotating only the intermediate support 3, and, even when a radio wave absorber is attached to the surface of the wall which is a structure and to the rear-surface side, which is the second-end side, of the panel base 1 or even when the distance from the first flange 2b of the attachment 2 to the rear surface of the panel base 1 is somewhat long, removal work of the panel base 1 is easy. Thus, work before maintenance work becomes easier.

After the end of the maintenance work, the panel base 1 only has to be attached to the attachment 2 via the intermediate support 3 in an attachment manner which is the same as that at the time of attachment.

As mentioned above, the connector panel according to the first embodiment has configuration in which the disc-shaped panel base 1 having the first screw portion 1a formed on its outer circumferential surface is to be attached to the attachment 2 via the intermediate support 3 whose inner circumferential surface has the third screw portion 3c to which the first screw portion 1a is to be screwed, and whose outer circumferential surface has the fourth screw portion 3e to which the second screw portion 2d of the attachment 2 is to be screwed. Thus, simple operation of rotating the intermediate support 3 can remove the panel base 1 from the attachment 2 and attach the panel base 1 to the attachment 2, and therefore removal and attachment work is easy.

Moreover, since the panel base 1 can be removed from the attachment 2 without rotating the panel base 1, the panel base 1 can be removed from the attachment 2 without removing, from the connectors 4, the second harness cables arranged on the side where the panel base 1 is not exposed.

Since each of the panel base 1, the attachment 2 and the intermediate support 3 is a conductive material, the shield performance can be ensured.

The fourth screw portion 3e in the intermediate support 3 has the male parallel screw 3e1 at the beginning portion of its screw thread, and has, at the terminating portion of the screw thread, the male taper screw 3e2 which increases in size toward the terminating end. As a result, the taper screw 3e2 enhances the tightness of contact between the second screw portion 2d and the fourth screw portion 3e, and enhances the tightness of contact between the first screw portion 1a and the third screw portion 3c, thereby enhancing the shield performance.

Furthermore, since the taper screw 3e2 elastically deforms due to the plurality of slits 3d provided at a portion of the second cylindrical portion 3a where the fourth screw portion 3e is formed, the shield performance improves further.

### Second Embodiment

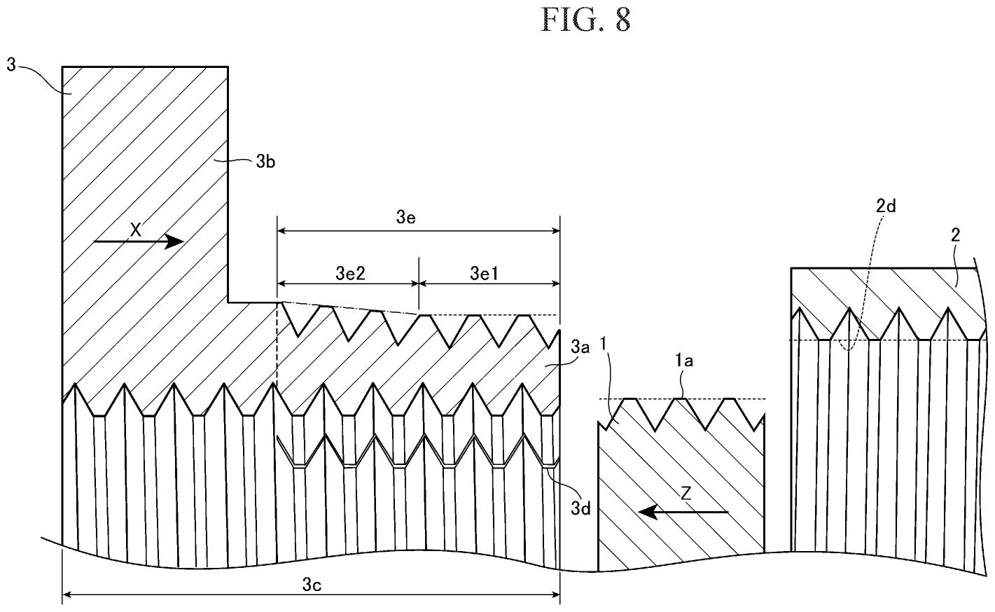

A connector panel according to a second embodiment is explained on the basis of FIG. 8.

The connector panel according to the second embodiment is different in that, while the connector panel according to the first embodiment has configuration in which the direction of screw engagement between the first screw portion 1a in the panel base 1 and the third screw portion 3c in the intermediate support 3 is opposite to the direction of screw engagement between the second screw portion 2d in the attachment 2 and the fourth screw portion 3e in the intermediate support 3, they are the same direction, that is, they have screw structures of either left-hand screws or right-hand screws. The second embodiment is the same as the first embodiment in other respects.

Note that reference signs in FIG. 8 that are identical to reference signs depicted in FIG. 1 to FIG. 7 represent identical or equivalent portions.

A manner of attachment of the connector panel according to the second embodiment to an opening which is a through hole of a wall of an electromagnetic anechoic chamber which is a structure is explained.

First, an attachment 2 is fixed to the opening provided in the wall which is a structure. The manner of fixation is the same as that for the connector panel according to the first embodiment.

Next, as depicted in FIG. 8, the front surface, which is on a first-end side, of a panel base 1 and the open end on a second-end side of an intermediate support 3 are caused to face each other in a coaxial state, a first screw portion 1a of the panel base 1 is pressed against a third screw portion 3c of the intermediate support 3, and the intermediate support 3 is rotated clockwise.

At this time, the panel base 1 is not rotated, but only the intermediate support 3 is rotated clockwise. Since the first screw portion 1a is screwed to the third screw portion 3c, and they have right-hand screw structures, the panel base 1 advances in the Z direction in the figure, and the panel base 1 is loosely attached to the intermediate support 3.

Although not depicted in FIG. 8, each of a plurality of connectors 4 attached to the panel base 1 is connected with a second harness cable at its second terminal provided at a second-end portion. However, the second harness cables, each of which is connected to the corresponding one of the plurality of connectors 4, are not twisted since the panel base 1 is not rotated.

In this state, the open end on the second-end side of the intermediate support 3 and the open end on a first-end side of the attachment 2 are caused to face each other in a coaxial state, a fourth screw portion 3e of the intermediate support 3 is pressed against a second screw portion 2d of the attachment 2, and the intermediate support 3 is rotated clockwise.

Then, since a parallel screw 3e1 of the fourth screw portion 3e is screwed to the second screw portion 2d, and they have right-hand screw structures, the intermediate support 3 advances in the X direction which is opposite to the Z direction in the figure, and thereby the intermediate support 3 is attached to the attachment 2. Simultaneously, the panel base 1 advances in the Z direction in the figure, and thereby the panel base 1 is attached to the intermediate support 3.

The reason why the intermediate support 3 advances in the direction which is opposite to the Z direction in the figure, and the panel base 1 advances in the Z direction in the figure when only the intermediate support 3 is rotated clockwise is because the direction of screw engagement between the first screw portion 1a in the panel base 1 and the third screw portion 3c in the intermediate support 3 is the same as the direction of screw engagement between the second screw portion 2d in the attachment 2 and the fourth screw portion 3e in the intermediate support 3, that is, they both have relationships of right-hand screws.

Accordingly, the panel base 1 is attached to the attachment 2 via the intermediate support 3 by rotating only the intermediate support 3, and thus the attachment work is easy.

In the end, work of attaching the panel base 1 to the attachment 2 ends in a state where the front surface, which is a first-end-side surface, of the panel base 1 is made flush with a first-end-side surface of a second flange portion 3b of the intermediate support 3, and a part of a taper screw 3e2 which is continuous with the parallel screw 3e1 of the fourth screw portion 3e in the intermediate support 3 is screwed to the second screw portion 2d of the attachment 2.

Since the panel base 1 is not rotated, but only the intermediate support 3 is rotated clockwise during the attachment work, the second harness cables are not twisted.

On the other hand, the manner of removal of the panel base 1 from the attachment 2 at a time of maintenance work when the second harness cables are inspected, repaired or changed, the plurality of connectors 4 or the like are inspected, repaired or changed, and so on is basically the reverse of the manner of attachment of the panel base 1 to the attachment 2 explained in the description above.

First, a first harness cable connected to the first terminal of each of the plurality of connectors 4 is removed.

Next, while keeping the panel base 1 unrotated, only the intermediate support 3 is rotated counterclockwise in a direction which is opposite to the direction in which the intermediate support 3 is rotated at the time of attachment.

Then, the panel base 1 advances in the direction which is opposite to the direction of the arrow Z in FIG. 8, and simultaneously the intermediate support 3 advances in the direction which is opposite to the X direction in the figure.

The fourth screw portion 3e of the intermediate support 3 is unscrewed from the second screw portion 2d of the attachment 2, and thus the intermediate support 3 can be removed from the attachment 2. Thereafter, the first screw portion 1a of the panel base 1 is unscrewed from the third screw portion 3c, and thus the panel base 1 can be removed from the intermediate support 3.

After the end of the maintenance work, the panel base 1 only has to be attached to the attachment 2 via the intermediate support 3 in an attachment manner which is the same as that at the time of attachment.

The connector panel according to the second embodiment attains advantages similar to those of the connector panel according to the first embodiment.

### Third Embodiment

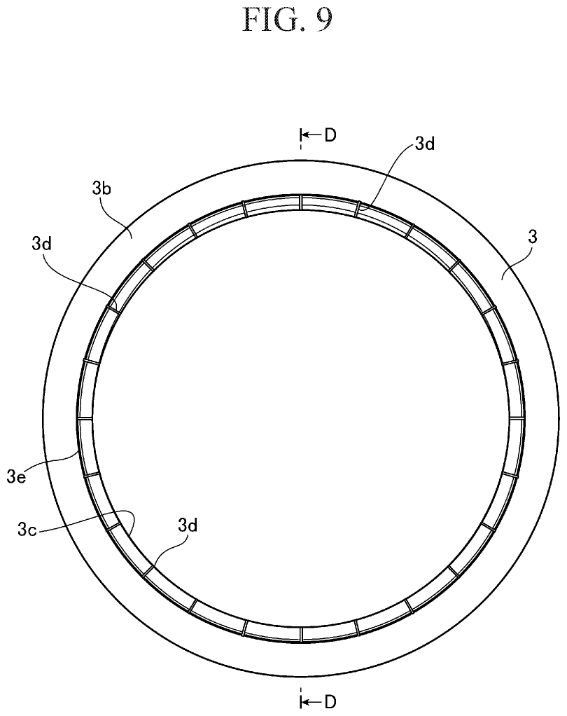

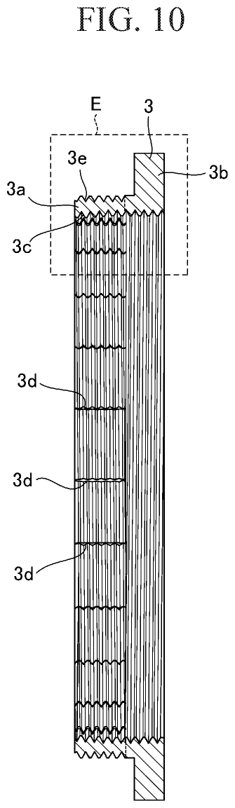

A connector panel according to a third embodiment is explained on the basis of FIG. 9 to FIG. 12.

An intermediate support 3 in the connector panel according to the third embodiment is different from the intermediate support 3 in the connector panel according to the first embodiment, and the connector panel according to the third embodiment is the same as the connector panel according to the first embodiment in other respects.

Note that reference signs in FIG. 9 to FIG. 12 that are identical to reference signs depicted in FIG. 1 to FIG. 7 represent identical or equivalent portions.

As depicted in FIG. 9 to FIG. 11, the intermediate support 3 has a second cylindrical portion 3a that communicates with a first cylindrical portion 2a of an attachment 2, and a second flange portion 3b that is formed integrally with the second cylindrical portion 3a at a first end of the second cylindrical portion 3a.

The intermediate support 3 has, over the entire inner circumferential surface thereof, a third screw portion 3c to which a first screw portion 1a of a panel base 1 is screwed.

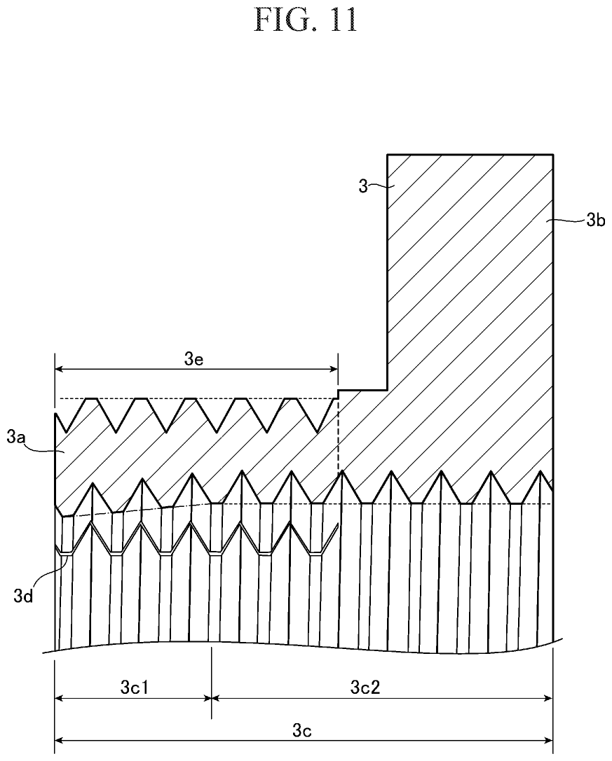

As depicted in FIG. 11, the third screw portion 3c is a female screw having a female taper screw 3c1 and a female parallel screw 3c2 that is continuous with the taper screw 3c1.

The taper screw 3c1 is formed at the beginning portion of the screw thread, that is, the portion starting from a second-end surface of the second cylindrical portion 3a, and has an internal diameter which increases from the second end of the second cylindrical portion 3a toward the parallel screw 3c2. In summary, the taper screw 3c1 has an internal diameter which decreases from the size of the parallel screw 3c2 toward the second end, which is the starting end, of the second cylindrical portion 3a.

The terminating end of the taper screw 3c1 is positioned on the second-end side with respect to the first end of the second cylindrical portion 3a.

The parallel screw 3c2 is formed at the terminating portion of the screw thread, that is, at the portion that is continuous with the terminating end of the taper screw 3c1 and extends to the first end of the intermediate support 3. The parallel screw 3c2 has the same screw size as the first screw portion 1a of the panel base 1.

Particularly, as represented by solid lines in FIG. 11, the intermediate support 3 has, at a portion of the second cylindrical portion 3a where a fourth screw portion 3e is formed, a plurality of slits 3d at constant intervals along the circumferential direction. The slits 3d are parallel to the central axis of the second cylindrical portion 3a.

Each slit 3d is a slit that is formed in the second cylindrical portion 3a continuously from the second-end surface of the second cylindrical portion 3a, that is, the starting end of the fourth screw portion 3e to the terminating end of the fourth screw portion 3e, while penetrating the second cylindrical portion 3a from its outer surface to its inner surface.

That is, the slits 3d are formed at a portion of the third screw portion 3c positioned in the second cylindrical portion 3a. The intermediate support 3 has, over the entire outer circumferential surface of the second cylindrical portion 3a, the fourth screw portion 3e to which a second screw portion 2d of the attachment 2 is screwed.

The fourth screw portion 3e is a male parallel screw. The fourth screw portion 3e has the same screw size as the second screw portion 2d of the attachment 2.

The direction of screw engagement between the first screw portion 1a in the panel base 1 and the third screw portion 3c in the intermediate support 3 is opposite to the direction of screw engagement between the second screw portion 2d in the attachment 2 and the fourth screw portion 3e in the intermediate support 3. That is, the direction of screw engagement between the first screw portion 1a and third screw portion 3c and the direction of screw engagement between the second screw portion 2d and the fourth screw portion 3e have a relationship in which one is a direction of left-hand screws, and the other is a direction of right-hand screws.

The manner of attachment of the connector panel according to the third embodiment to an opening which is a through hole of a wall of an electromagnetic anechoic chamber which is a structure is basically the same as the manner of attachment of the connector panel according to the first embodiment to the opening of the structure.

It should be noted that while the connector panel according to the first embodiment has configuration in which the third screw portion 3c is a female parallel screw, and the fourth screw portion 3e is a male screw having the male parallel screw 3e1 and the male taper screw 3e2, the connector panel according to the third embodiment is different in that the third screw portion 3c is a female screw having the female taper screw 3c1 and the female parallel screw 3c2, and the fourth screw portion 3e is a male parallel screw. Accordingly, the manner how the panel base 1, the attachment 2 and the intermediate support 3 tightly contact one another in a state where the panel base 1 is attached to the attachment 2 via the intermediate support 3 is different.

That is, first, the rear surface, which is the second-end side, of the panel base 1 and the open end on the first-end side of the intermediate support 3 are caused to face each other in a coaxial state, the first screw portion 1a of the panel base 1 is pressed against the parallel screw 3c2 of the third screw portion 3c in the intermediate support 3, the intermediate support 3 is rotated clockwise, and thereby the panel base 1 is loosely attached to the intermediate support 3.

In this loosely attached state, the open end on the second-end side of the intermediate support 3 and the open end on the first-end side of the attachment 2 are caused to face each other in a coaxial state, the fourth screw portion 3e of the intermediate support 3 is pressed against the second screw portion 2d of the attachment 2, and the intermediate support 3 is rotated clockwise.

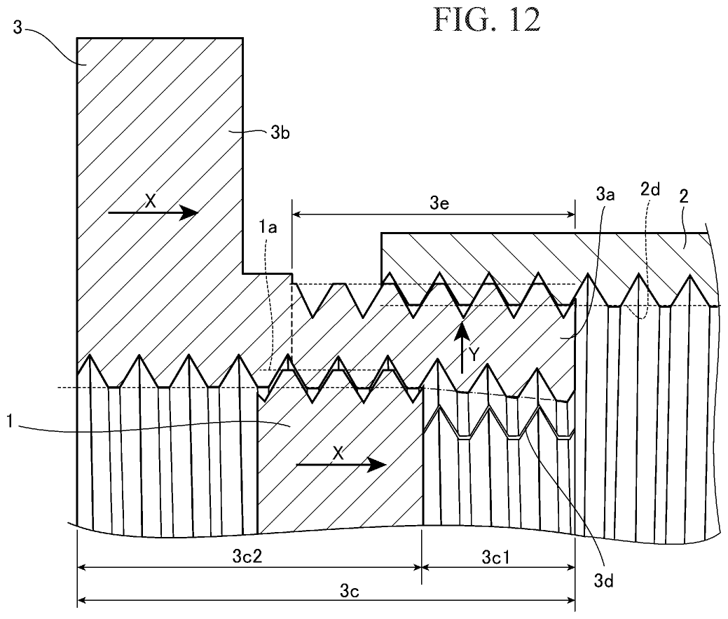

Then, as depicted in FIG. 12, the intermediate support 3 advances in the X direction in the figure, and the intermediate support 3 is attached to the attachment 2. Simultaneously, the panel base 1 advances in the X direction in the figure, and the panel base 1 is attached to the intermediate support 3. In the attachment of the panel base 1, the panel base 1 is not rotated.

When the fourth screw portion 3e of the intermediate support 3 is screwed to the second screw portion 2d of the attachment 2, the first screw portion 1a of the panel base 1 is screwed to the third screw portion 3c of the intermediate support 3, the intermediate support 3 and the panel base 1 advance in the X direction in the figure, and the first screw portion 1a of the panel base 1 reaches the taper screw 3c1 of the third screw portion 3c in the intermediate support 3, the internal diameter of the taper screw 3c1 gradually decreases. Thus, force is applied in the direction of the arrow Y in the figure by the taper screw 3c1 being pressed by the first screw portion 1a of the panel base 1.

As a result, the panel base 1 is caused to tightly contact the intermediate support 3 rigidly. Furthermore, a portion of the intermediate support 3 where the taper screw 3c1 is formed elastically deforms in the direction of the arrow Y in the figure, due to a plurality of slits 3d formed at a portion of the second cylindrical portion 3a where the fourth screw portion 3e is formed in the intermediate support 3. Thereby, the fourth screw portion 3e also elastically deforms in the direction of the arrow Y in the figure similarly to the taper screw 3c1. Thereby, the fourth screw portion 3e is caused to tightly contact the second screw portion 2d of the attachment 2 rigidly. Thereby, the intermediate support 3 also is caused to tightly contact the attachment 2 rigidly.

In this manner, the panel base 1 is attached to the attachment 2 via the intermediate support 3 by rotational operation of the intermediate support 3. The taper screw 3c1 and fourth screw portion 3e of the intermediate support 3 elastically deform before the final attachment stage is reached. Thereby, the tightness of contact between the first screw portion 1a and the third screw portion 3c improves, and the tightness of contact between the second screw portion 2d and the fourth screw portion 3e improves. Thus, the shield performance as a connector panel further improves.

The manner of removal of the panel base 1 from the attachment 2 is basically the same as the manner of removal in the connector panel according to the first embodiment. When the intermediate support 3 is rotated counterclockwise, both the intermediate support 3 and the panel base 1 advance in the direction opposite to the direction of the arrow X in FIG. 12, and first the intermediate support 3 can be removed from the attachment 2.

Work such as maintenance work may be performed in this state.

By further rotating the intermediate support 3 counterclockwise, the panel base 1 can be removed from the intermediate support 3.

After the end of the maintenance work, the panel base 1 only has to be attached to the attachment 2 via the intermediate support 3 in an attachment manner which is the same as that at the time of attachment.

The connector panel according to the third embodiment attains advantages similar to those of the connector panel according to the first embodiment.

### Fourth Embodiment

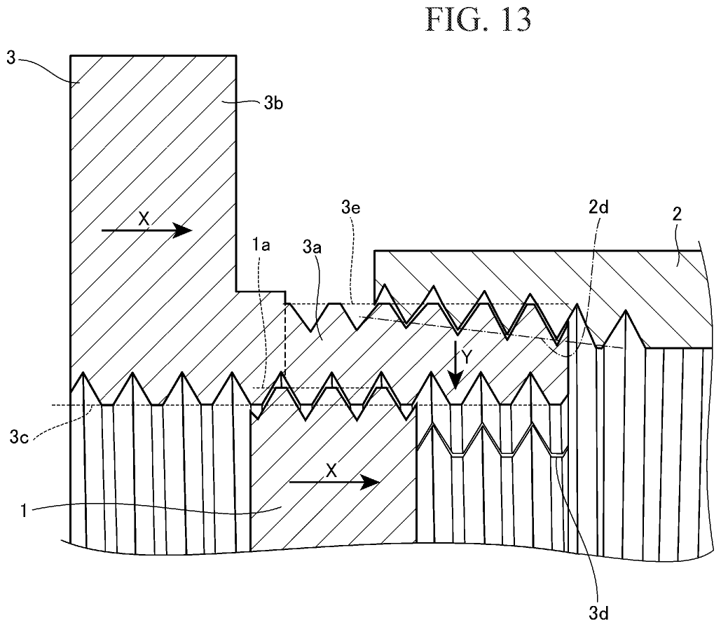

A connector panel according to a fourth embodiment is explained on the basis of FIG. 13.

The connector panel according to the fourth embodiment has a second screw portion 2d of an attachment 2 and a fourth screw portion 3e of an intermediate support 3 whose screw structures are different from the screw structures of the second screw portion 2d of the attachment 2 and the fourth screw portion 3e of the intermediate support 3 in the connector panel according to the first embodiment, and is the same in other respects.

Note that reference signs in FIG. 13 that are identical to reference signs depicted in FIG. 1 to FIG. 7 represent identical or equivalent portions.

That is, a first screw portion 1a of a panel base 1 is a male parallel screw, the second screw portion 2d of the attachment 2 is a female taper screw, a third screw portion 3c of the intermediate support 3 is a female parallel screw, and the fourth screw portion 3e of the intermediate support 3 is a male parallel screw.

The taper screw which is the second screw portion 2d of the attachment 2 has an internal diameter which gradually decreases from the starting end of the screw thread, that is, a first end of a first cylindrical portion 2a, toward the terminating end of the screw thread.

The manner of attachment of the connector panel according to the fourth embodiment to an opening which is a through hole of a wall of an electromagnetic anechoic chamber which is a structure is basically the same as the manner of attachment of the connector panel according to the first embodiment to the opening of the structure.

It should be noted that since the screw structures of the second screw portion 2d of the attachment 2 and the fourth screw portion 3e of the intermediate support 3 are different from those of the connector panel according to the first embodiment, the manner how the panel base 1, the attachment 2 and the intermediate support 3 tightly contact one another in a state where the panel base 1 is attached to the attachment 2 via the intermediate support 3 is different.

That is, first, the rear surface, which is the second-end side, of the panel base 1 and the open end on the first-end side of the intermediate support 3 are caused to face each other in a coaxial state, the first screw portion 1a of the panel base 1 is pressed against the third screw portion 3c of the intermediate support 3, the intermediate support 3 is rotated clockwise, and thereby the panel base 1 is loosely attached to the intermediate support 3.

In this loosely attached state, the open end on the second-end side of the intermediate support 3 and the open end on the first-end side of the attachment 2 are caused to face each other in a coaxial state, the fourth screw portion 3e of the intermediate support 3 is pressed against the second screw portion 2d of the attachment 2, and the intermediate support 3 is rotated clockwise.

Then, as depicted in FIG. 13, the intermediate support 3 advances in the X direction in the figure, and the intermediate support 3 is attached to the attachment 2. Simultaneously, the panel base 1 advances in the X direction in the figure, and the panel base 1 is attached to the intermediate support 3. In the attachment of the panel base 1, the panel base 1 is not rotated.

When the fourth screw portion 3e of the intermediate support 3 is screwed to the second screw portion 2d of the attachment 2, and the intermediate support 3 advances in the X direction in the figure, the internal diameter of the second screw portion 2d of the attachment 2 gradually decreases. Thus, force is applied in the direction of the arrow Y in the figure by the fourth screw portion 3e being pressed by the second screw portion 2d.

As a result, a second cylindrical portion 3a of the intermediate support 3 elastically deforms in the direction of the arrow Y in the figure, due to a plurality of slits 3d that are formed at a portion of the second cylindrical portion 3a where the fourth screw portion 3e is formed in the intermediate support 3. Thereby, the second screw portion 2d and the fourth screw portion 3e are caused to tightly contact each other rigidly. Thereby, the intermediate support 3 is caused to tightly contact the attachment 2 rigidly. Simultaneously, the panel base 1 advances in the X direction in the figure, and the third screw portion 3c also elastically deforms in the direction of the arrow Y in the figure similarly to the fourth screw portion 3e. Thereby, the third screw portion 3c is caused to tightly contact the first screw portion 1a of the panel base 1 rigidly. Thereby, the panel base 1 is caused to tightly contact the intermediate support 3 rigidly.

In this manner, the panel base 1 is attached to the attachment 2 via the intermediate support 3 by rotational operation of the intermediate support 3. The fourth screw portion 3e and the third screw portion 3c of the intermediate support 3 elastically deform before the final attachment stage is reached. Thereby, the tightness of contact between the second screw portion 2d and the fourth screw portion 3e, and the tightness of contact between the first screw portion 1a and the third screw portion 3c improve. Thus, the shield performance as a connector panel further improves.

The manner of removal of the panel base 1 from the attachment 2 is basically the same as the manner of removal in the connector panel according to the first embodiment. When the intermediate support 3 is rotated counterclockwise, both the intermediate support 3 and the panel base 1 advance in the direction opposite to the direction of the arrow X in FIG. 13, and first the intermediate support 3 can be removed from the attachment 2.

Work such as maintenance work may be performed in this state.

By further rotating the intermediate support 3 counterclockwise, the panel base 1 can be removed from the intermediate support 3.

After the end of the maintenance work, the panel base 1 only has to be attached to the attachment 2 via the intermediate support 3 in an attachment manner which is the same as that at the time of attachment.

The connector panel according to the fourth embodiment attains advantages similar to those of the connector panel according to the first embodiment.

### Fifth Embodiment

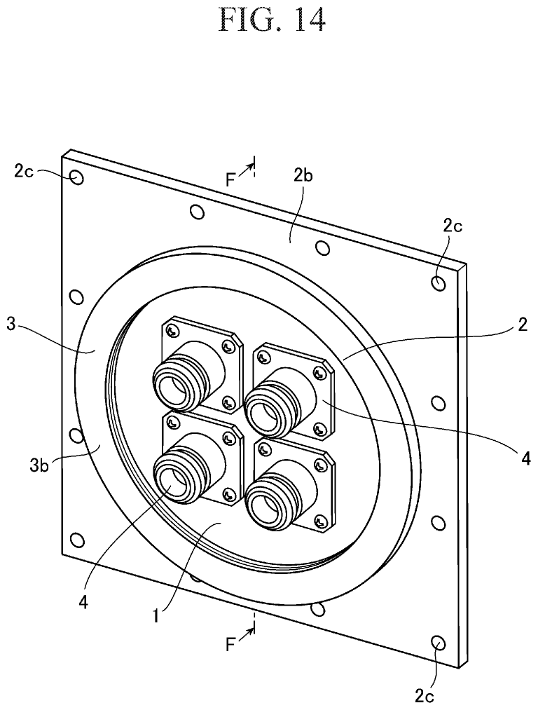

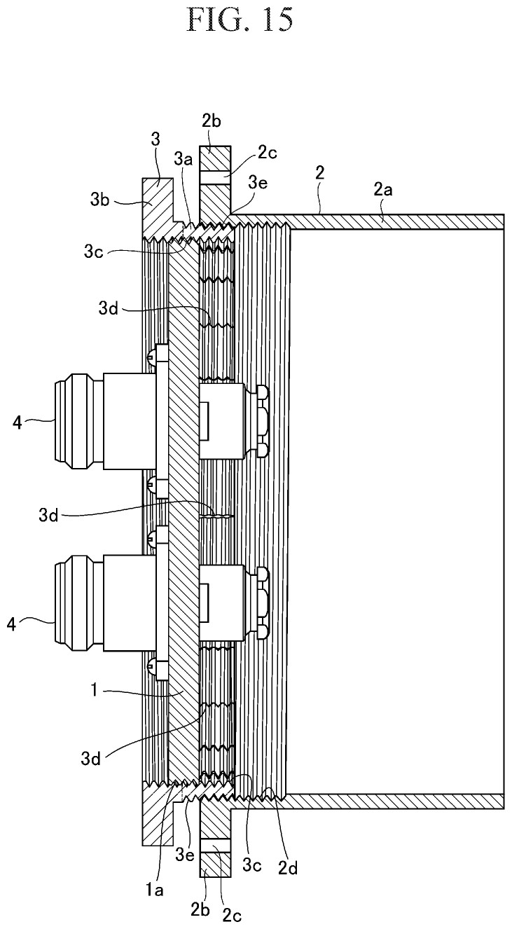

A connector panel according to a fifth embodiment is explained on the basis of FIG. 14 and FIG. 15.

In the connector panel according to the first embodiment, the second screw portion 2d of the attachment 2 is formed on the first-end portion of the inner circumferential surface of the first cylindrical portion 2a positioned opposite the first flange 2b. On the other hand, in the connector panel according to the fifth embodiment, a second screw portion 2d and a first flange 2b are positioned at a first end of a first cylindrical portion 2a. The connector panel according to the fifth embodiment differs from the connector panel according to the first embodiment in this respect, and is the same in other respects.

Note that reference signs in FIG. 14 and FIG. 15 that are identical to reference signs depicted in FIG. 1 to FIG. 7 represent identical or equivalent portions.

That is, an attachment 2 has the first cylindrical portion 2a and the first flange 2b formed integrally with the first cylindrical portion 2a at the first end of the first cylindrical portion 2a. Further, the attachment 2 has the second screw portion 2d that is formed at the first-end portion, positioned on the same side as the first flange 2b, of the inner circumferential surface of the first cylindrical portion 2a.

The first cylindrical portion 2a of the attachment 2 is inserted into an opening provided in a structure in such a manner that the outer circumferential surface of the first cylindrical portion 2a tightly contacts the structure, and the first flange 2b is fixed to an edge portion at multiple points by screws that penetrate screw through holes 2c. The edge portion is an edge portion circumscribing the opening, that is, an edge portion, on the rear-surface side, circumscribing the opening provided in a wall which is a structure.

A panel base 1 and an intermediate support 3 are attached similarly to the connector panel according to the first embodiment from the first-end side of the attachment 2 where the first flange 2b is positioned.

Removal of the panel base 1 from the attachment 2, and attachment of the panel base 1 to the attachment 2 for maintenance work or the like are performed similarly to those for the connector panel according to the first embodiment.

The connector panel according to the fifth embodiment attains advantages similar to those of the connector panel according to the first embodiment.

Note that, similarly to the connector panel according to the second embodiment, in the connector panel according to the fifth embodiment, the direction of screw engagement between a first screw portion 1a in the panel base 1 and a third screw portion 3c in the intermediate support 3 may be the same as the direction of screw engagement between the second screw portion 2d in the attachment 2 and a fourth screw portion 3e in the intermediate support 3.

In addition, similarly to the connector panel according to the third embodiment, in the connector panel according to the fifth embodiment, the first screw portion 1a of the panel base 1 may be a male parallel screw, the second screw portion 2d of the attachment 2 may be a female parallel screw, the third screw portion 3c of the intermediate support 3 may include a female taper screw 3c1 and a female parallel screw 3c2, and the fourth screw portion 3e of the intermediate support 3 may be a male parallel screw.

Furthermore, similarly to the connector panel according to the fourth embodiment, in the connector panel according to the fifth embodiment, the first screw portion 1a of the panel base 1 may be a male parallel screw, the second screw portion 2d of the attachment 2 may be a female taper screw, the third screw portion 3c of the intermediate support 3 may be a female parallel screw, and the fourth screw portion 3e of the intermediate support 3 may be a male parallel screw.

Note that any combinations of embodiments, modifications of any components in embodiments or omission of any components in embodiments are/is possible.

### INDUSTRIAL APPLICABILITY

The connector panels according to present disclosure are suitable as connector panels that are attached to an opening provided in a structure that serves as a shield between the inside area and the outside area, in particular a wall that serves as a shield between the areas inside and outside a shielded closed space such as an electromagnetic anechoic chamber, and are for electrically connecting the areas inside and outside the closed space by using a plurality of signal cables or the like.

### REFERENCE SIGNS LIST

1: panel base, la: first screw portion, 2: attachment, 2a: first cylindrical portion, 2b: flange, 2c: screw through hole, 2d: second screw portion, 3: intermediate support, 3a: second cylindrical portion, 3b: second flange, 3c: third screw portion, 3c1: taper screw, 3c2: parallel screw, 3d: slit, 3e: fourth screw portion, 3e1: parallel screw, 3e2: taper screw, 4: connector.

1. A connector panel comprising:
a disc-shaped panel base that has a first screw portion on an outer circumferential surface of the panel base and to which a plurality of connectors are to be attached in such a manner that a first-end portion of each of the plurality of connectors protrudes on a first-surface side of the panel base, and a second-end portion of each of the plurality of connectors protrudes on a second-surface side of the panel base;
an attachment that has a first cylindrical portion and a flange formed integrally with the first cylindrical portion, the flange being configured to be fixed to an edge portion circumscribing an opening provided in a structure that serves as a shield between an area inside the structure and an area outside the structure, the attachment having a second screw portion at a first-end portion of an inner circumferential surface of the first cylindrical portion; and
an intermediate support whose inner circumferential surface has a third screw portion to which the first screw portion of the panel base is to be screwed, and whose outer circumferential surface has a fourth screw portion to which the second screw portion of the attachment is to be screwed, the intermediate support having a second cylindrical portion that is to be disposed coaxially with the first cylindrical portion of the attachment.

2. The connector panel according to claim 1, wherein each of the panel base, the attachment and the intermediate support is a conductive material.

3. The connector panel according to claim 1, wherein each of the plurality of connectors is an N-type connector.

4. The connector panel according to claim 1, wherein
the first screw portion in the panel base is a male screw,
the second screw portion in the attachment is a female screw,
the third screw portion in the intermediate support is a female screw, and the fourth screw portion in the intermediate support is a male screw, and
a direction of screw engagement between the first screw portion and the third screw portion is opposite to a direction of screw engagement between the second screw portion and the fourth screw portion.

5. The connector panel according to claim 1, wherein
the first screw portion in the panel base is a male parallel screw,
the second screw portion in the attachment is a female parallel screw,
the third screw portion in the intermediate support is a female parallel screw, and the fourth screw portion in the intermediate support has a male parallel screw at a beginning portion of a screw thread of the fourth screw portion, and has a male taper screw at a terminating portion of the screw thread of the fourth screw portion, the male taper screw having an outer diameter which increases toward a terminating end, and
a direction of screw engagement between the first screw portion and the third screw portion is opposite to a direction of screw engagement between the second screw portion and the fourth screw portion.

6. The connector panel according to claim 1, wherein
the first screw portion in the panel base is a male screw,
the second screw portion in the attachment is a female screw,
the third screw portion in the intermediate support is a female screw, and the fourth screw portion in the intermediate support is a male screw, and
a direction of screw engagement between the first screw portion and the third screw portion is the same as a direction of screw engagement between the second screw portion and the fourth screw portion.

7. The connector panel according to claim 1, wherein
the first screw portion in the panel base is a male parallel screw,
the second screw portion in the attachment is a female parallel screw,
the third screw portion in the intermediate support is a female parallel screw, and the fourth screw portion in the intermediate support has a male parallel screw at a beginning portion of a screw thread of the fourth screw portion, and has a male taper screw at a terminating portion of the screw thread of the fourth screw portion, the male taper screw having an outer diameter which increases toward a terminating end, and
a direction of screw engagement between the first screw portion and the third screw portion is the same as a direction of screw engagement between the second screw portion and the fourth screw portion.

8. The connector panel according to claim 1, wherein
the first screw portion in the panel base is a male parallel screw,
the second screw portion in the attachment is a female parallel screw,
the third screw portion in the intermediate support has a parallel screw at a terminating portion of a screw thread of the third screw portion, and has a female taper screw at a beginning portion of the screw thread of the third screw portion, and the fourth screw portion in the intermediate support is a male parallel screw, the female taper screw having an internal diameter which decreases toward a starting end, and
a direction of screw engagement between the first screw portion and the third screw portion is opposite to a direction of screw engagement between the second screw portion and the fourth screw portion.

9. The connector panel according to claim 1, wherein
the first screw portion in the panel base is a male parallel screw,
the second screw portion in the attachment is a female taper screw having an internal diameter which decreases from a starting end toward a terminating end of a screw thread of the second screw portion,
the third screw portion in the intermediate support is a female parallel screw, and the fourth screw portion in the intermediate support is a male parallel screw, and
a direction of screw engagement between the first screw portion and the third screw portion is opposite to a direction of screw engagement between the second screw portion and the fourth screw portion.

10. The connector panel according to claim 5, wherein the intermediate support has a plurality of slits at a portion where the fourth screw portion is formed, the plurality of slits being parallel to a central axis of the second cylindrical portion.

11. The connector panel according to claim 1, wherein the flange of the attachment is positioned on a second end of the first cylindrical portion.

12. The connector panel according to claim 1, wherein the flange of the attachment is positioned on a first end of the first cylindrical portion.

13. The connector panel according to claim 7, wherein the intermediate support has a plurality of slits at a portion where the fourth screw portion is formed, the plurality of slits being parallel to a central axis of the second cylindrical portion.

14. The connector panel according to claim 8, wherein the intermediate support has a plurality of slits at a portion where the fourth screw portion is formed, the plurality of slits being parallel to a central axis of the second cylindrical portion.

15. The connector panel according to claim 9, wherein the intermediate support has a plurality of slits at a portion where the fourth screw portion is formed, the plurality of slits being parallel to a central axis of the second cylindrical portion.
